(19) United States
(12) Patent Application Publication
(10) Pub. No.: US 2026/0021014 A1
(43) Pub. Date: Jan. 22, 2026

(54) MASSAGE MACHINE

(71) Applicant: FUJI MEDICAL INSTRUMENTS MFG. CO., LTD., Osaka (JP)

(72) Inventors: Takeshi FURUTANI, Osaka (JP); Jumpei YOKOYAMA, Osaka (JP); Yoshinori ONO, Osaka (JP)

(73) Assignee: FUJI MEDICAL INSTRUMENTS MFG. CO., LTD., Osaka (JP)

(21) Appl. No.: 19/243,243

(22) Filed: Jun. 19, 2025

(30) Foreign Application Priority Data
Jul. 19, 2024 (JP) 2024-115672

(51) Int. Cl. A61H 15/00; A61H 7/00; A61H 23/00

(52) U.S. Cl. CPC A61H 15/0078; A61H 7/007; A61H 23/006; A61H 2015/0014; A61H 2201/0149; A61H 2201/1207; A61H 2201/1623; A61H 2201/1635; A61H 2201/1676; A61H 2205/086; A61H 2205/108

(57) ABSTRACT

Provided is a massage machine including: a base; a seat part disposed at the base; a backrest part located on a back side of the seat part and reclinable relative to the base while being supported by a pivot fulcrum, and being configured to support a treatment element that moves while applying pressure against the body of a user to provide treatment to the user; an actuator that generates a driving force to recline and raise at least the backrest part; a driving force transmission part that transmits the driving force of the actuator to the backrest part; and a slide mechanism that slides the pivot fulcrum in a forward direction in accordance with the reclining of the backrest part.

### CROSS-REFERENCE TO RELATED APPLICATION

This application claims benefit of and priority to Japanese Patent Application No. 2024-115672 filed Jul. 19, 2024, which is hereby incorporated herein by reference in its entirety.

### FIELD

The present disclosure relates to a chair-type massage machine including a seat part and a reclining backrest part.

### BACKGROUND

Conventionally, there has been a chair-type massage machine as described, for example, in JP 6204715 B. A chair-type massage machine is provided with a reclining backrest part. When the backrest part is reclined, the backrest part falls to the back side of the massage machine. For this reason, in the case of the installation situation in which a wall or a pillar is positioned on the back side of the massage machine, it is necessary to install the massage machine away from the wall or the pillar at a distance which accommodates backward falling of the backrest part. Therefore, there is a restriction on the installation position of the massage machine.

### SUMMARY

An object of the present disclosure is to provide a massage machine in which the amount of movement to the back side of the massage machine is suppressed when reclining the backrest part.

The following presents a simplified summary of the disclosure disclosed herein in order to provide a basic understanding of some aspects of the disclosure. This summary is not an extensive overview of the disclosure. It is intended to neither identify key or critical elements of the disclosure nor delineate the scope of the disclosure. Its sole purpose is to present some concepts of the disclosure in a simplified form as a prelude to the more detailed description that is presented later.

A massage machine according to the present disclosure includes: a base; a seat part disposed at the base; a backrest part located on a back side of the seat part and reclinable relative to the base while being supported by a pivot fulcrum, and being configured to support a treatment element that moves while applying pressure against the body of a user to provide treatment to the user; an actuator that generates a driving force to recline and raise at least the backrest part; a driving force transmission part that transmits the driving force of the actuator to the backrest part; and a slide mechanism that allows the pivot fulcrum to shift in a forward direction in accordance with the reclining of the backrest part.

### BRIEF DESCRIPTION OF DRAWINGS

The foregoing and other features of the present disclosure will become apparent from the following description and drawings of an illustrative embodiment of the disclosure.

FIG. 1 is a right side view of a massage machine according to one embodiment of the present disclosure, showing a backrest part in a standing state (with exterior members removed, the same shall apply hereinafter).

FIG. 2 is a right side view showing the backrest part of the massage machine in a reclining state.

FIG. 3 is an enlarged perspective view of a main part of the massage machine, showing a combination of a guiding part and a guided part on the right side with respective to the massage machine with an identical configuration on the left side omitted, corresponding to the standing state of the backrest part.

FIG. 4 is an enlarged perspective view of the main part of the massage machine, showing the combination of the guiding part and the guided part on the right side with respect to the massage machine with an identical configuration on the left side omitted, corresponding to the reclining state of the backrest part.

FIG. 5 is a longitudinal cross-sectional view (viewed from the left side with reference to the massage machine) of the combination of the guiding part and the guided part on the left side as viewed from a user, in the standing state of the backrest part of the massage machine.

FIG. 6 is a longitudinal cross-sectional view (viewed from the left side with reference to the massage machine) of the combination of the guiding part and the guided part on the left side as viewed from the user, in the reclining state of the backrest part of the massage machine.

FIG. 7 is an explanatory diagram of control of the range of movement of a treatment element in the massage machine.

### DETAILED DESCRIPTION OF THE PREFERRED EMBODIMENT

Now, a massage machine 1 according to one embodiment of the present disclosure will be described. It should be noted that in the following directional expression, the side on which a backrest part 4 is disposed in the massage machine 1 is referred to as “back side”, and the opposite side thereto is referred to as “front side”. Also, the left and right are determined based on the massage machine 1, that is, as seen from a user who is sitting on the massage machine 1. Left and right direction is also expressed as “width direction” when left or right is not distinguished.

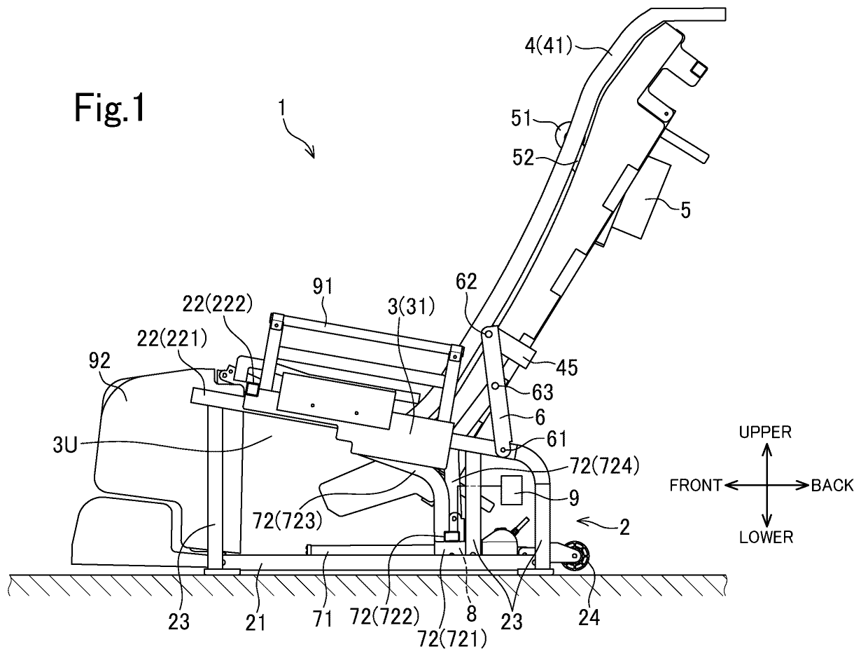

The massage machine 1 of this embodiment is constructed as shown in FIG. 1 (exterior members such as a cover are not shown in each figure, but the internal mechanism portion is shown). The massage machine 1 is a chair-type massage machine (massage chair). The massage machine 1 includes mainly a base 2 disposed on a floor of the installation site, a seat part 3 disposed at the base 2, a backrest part 4 located on a back side of the seat part 3, and a treatment part 5 which is a unit provided with a treatment element 51. The massage machine 1 includes armrests and an ottoman in the same manner as a conventional massage machine. Only a frame 91 is illustrated for the armrest, and only a cover 92 is illustrated for the ottoman.

The base 2 of this embodiment includes a lower frame 21, an upper frame 22, and vertical connecting frames 23. The lower frame 21 is a frame disposed close to and in parallel with a flower surface of the installation site. The lower frame 21 has a square frame shape in a plan view or a bottom view by combining straight rod parts including parts extending in the front and back direction, and parts extending in the width direction.

The upper frame 22 is a frame positioned above the lower frame 21. The upper frame 22 is combined with straight rod parts including an upper frame part 221 extending in the front and back direction, and a transverse frame part 222 extending in the width direction. In the upper frame 22, the part extending in the width direction (the transverse frame part 222 in this embodiment) is disposed only on the front side so as not to interfere with reclining of the backrest part 4. The upper frame part 221 is positioned so as to overlap in a planar view or a bottom view with respect to the parts extending in the front and back direction in the lower frame 21. The upper frame part 221 is disposed at a higher position on the front side than on the back side with respect to the floor surface and the lower frame 21, and is inclined upward toward the front side at a certain angle.

The vertical connecting frames 23 are frames extending in the vertical direction so as to connect the lower frame 21 and the upper frame 22 to each other. The vertical connecting frames 23 include one vertical connecting frame on the front side and two vertical connecting frames on the back side. Out of the vertical connecting frames 233, one on the front side and one on the back side each have a straight rod shape. The one vertical connecting frames 23 on the back side out of the vertical connecting frames 23 has a shape in which a lower part has a straight rod shape and an upper part has a curved shape to be in conformity with the inclination of the upper frame 22. These frames configured as described above are combined together so that the base 2 is formed in a three-dimensional frame shape. The vertical connecting frames 23 are provided with wheels 24 used for movement of the massage machine 1. The wheels 24 protrude backward from back ends of the back-side vertical connecting frames 23 and are grounded against the floor only when in use. The wheels 24 can be provided at back ends of the lower frame 21.

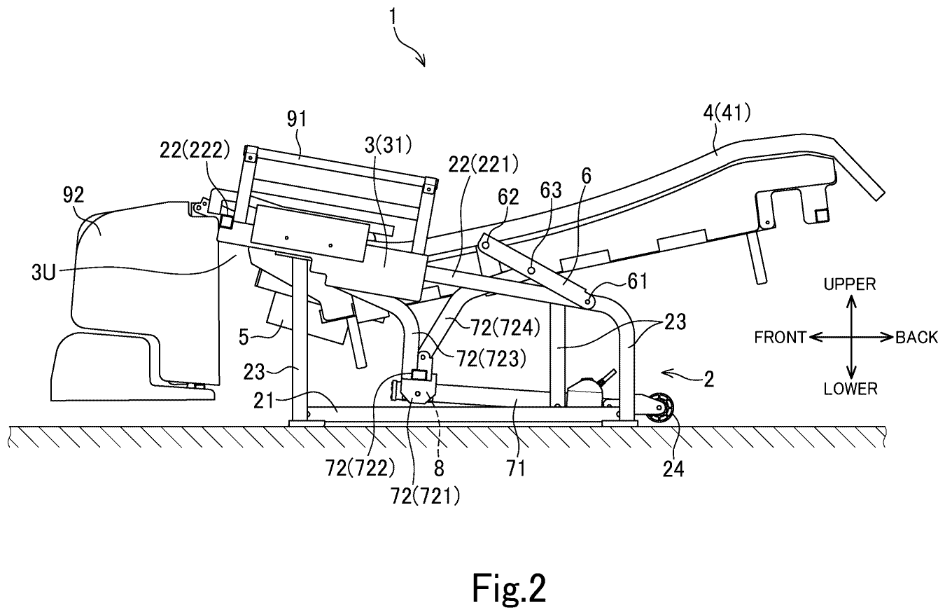

The seat part 3 is a part including a cushion member that abuts on the buttocks and the thighs of the user through an exterior member when the user is seated. A frame part 31, which is a part illustrated in the seat part 3, supports the cushion member. The frame part 31 is provided so that it can move forward and backward along the upper frame part 221 of the upper frame 22 at the base 2. Therefore, the seat part 3 moves forward and backward along the upper frame part 221. The upper frame part 221 is inclined forward. Therefore, the seat part 3 moves along the shape of the upper frame part 221 as shown in FIG. 1 (in the back position) and FIG. 2 (in the front position). When the seat part 3 moves forward, a part of it is positioned forward than the front end portion of the upper frame part 221. By a first arm 723 and a second arm 724, which will be described later, the seat part 3 and the backrest part 4 are linked to each other. A space 3U into which a front end portion of the reclined backrest part 4 and the treatment part 5 which has moved to the front end portion can enter is provided below the seat part 3. The space 3U is a space surrounded by the base 2 formed in a three-dimensional frame shape as described above, and the seat part 3 located above the base 2.

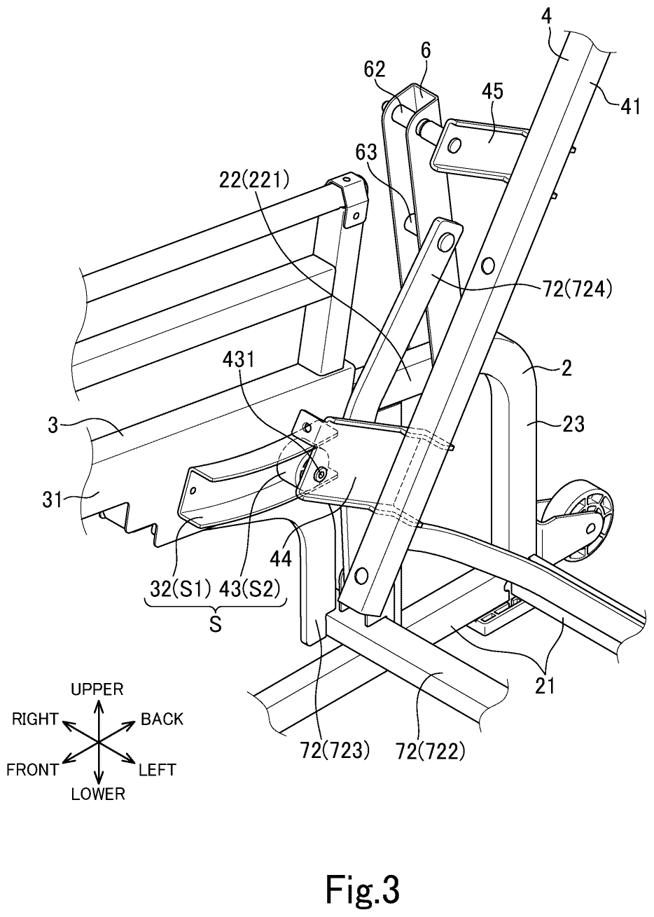

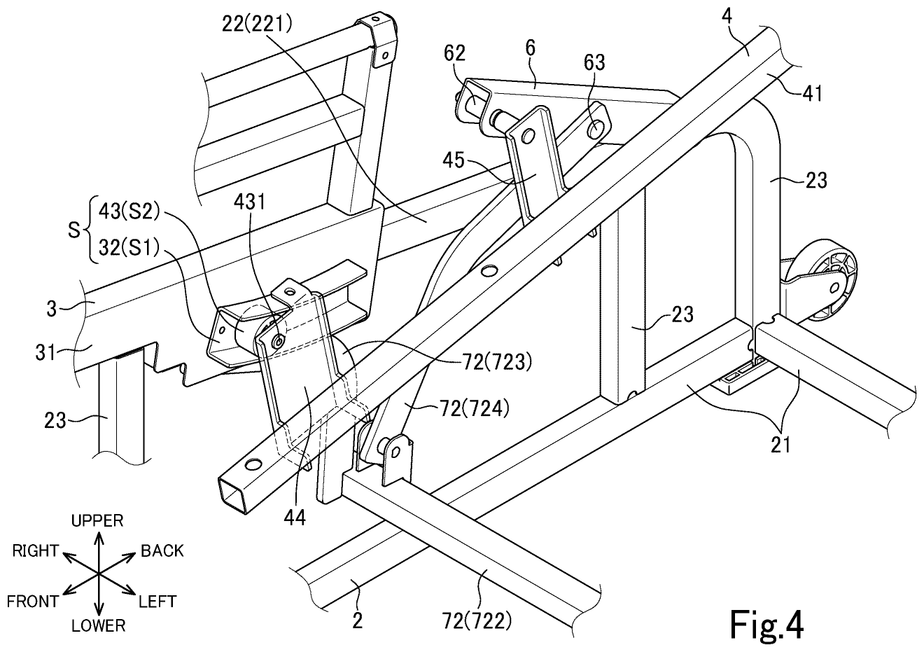

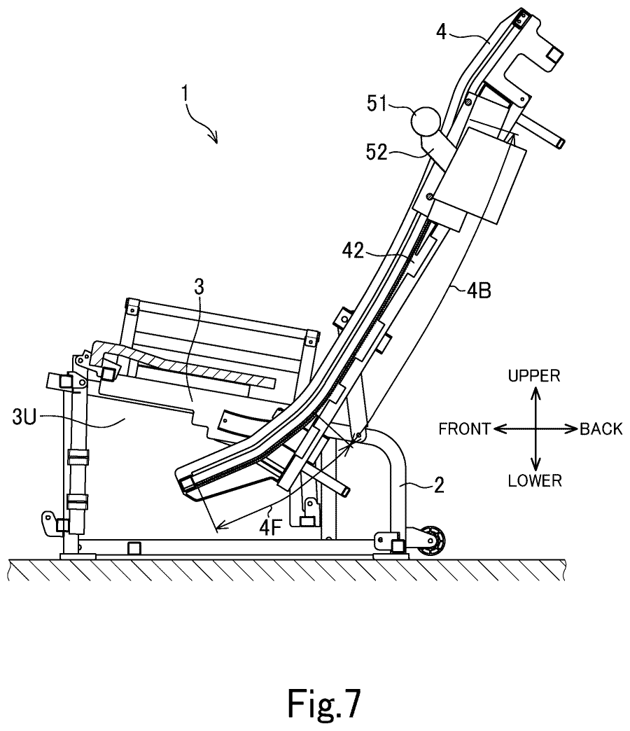

The backrest part 4 is provided so as to be reclinable relative to the base 2 while being supported by at least one pivot fulcrum 431 (in this embodiment, the pivot fulcrum 431 is provided in the roller 43, as shown in FIG. 3 and FIG. 4, and corresponds to the radial center of the roller 43). The backrest part 4 is reclined relative to the base 2 by pivoting around the pivot fulcrum 431. In other words, the pivot fulcrum 431 is a supporting point around which the backrest part 4 is pivoted to thereby allow the backrest part 4 to be reclined in the massage machine 1. In this embodiment, the roller 43 itself is configured to rotate, but if the pivot fulcrum 431 is able to perform the above-mentioned function, other configurations can be adopted. The backrest part 4 is also supported pivotally by a link part 6, but this pivotally supporting portion does not serve as a basis for reclining (does not perform the above-mentioned function) and does not fall under the above-mentioned pivot fulcrum. The front end portion (corresponding to an area 4F illustrated in FIG. 7) of the backrest part 4 is located in the space 3U provided below the seat part 3 when the backrest part 4 is reclined, as shown in FIG. 2. At this time, the treatment element 51 is located below the seat part 3 so that it can provide treatment to the buttocks and/or thighs of the user. More specifically, the backrest part 4 includes mainly a main frame part 41 which is schematically square-shaped, with two parallel parts arranged in the width direction, and parts extending backward from the seat part 3 having front ends and back ends respectively connected to each other in the width direction. Note that the detailed configuration of the backrest part 4 (rack 42, roller 43 will be described later) is omitted. The main frame part 41 is provided with a rack 42 having a plurality of teeth formed along the longitudinal direction. A pinion (not shown) included in the treatment part 5 engages the rack 42. The pinion is provided on a rotating shaft to be driven in the treatment part 5. The treatment part 5 can be moved along the longitudinal direction of the main frame part 41 by the combination of the rack 42 and the pinion (setting and controlling the movement range of the treatment part 5 will be described later). Therefore, the main frame part 41 guides the movement of the treatment part 5 in the longitudinal direction of the main frame part 41. The backrest part 4 supports the treatment element 51 through the treatment part 5, which is a unit to which the treatment element 51 is incorporated.

A cylindrical roller 43 is mounted on a lateral side of the front end portion of the backrest part 4 so as to protrude in the width direction and be pivotable around its radial center, as shown in FIG. 3 and FIG. 4. In this embodiment, the roller 43 is attached to the main frame part 41 through a bracket 44 fixed to the lateral side of the main frame part 41. The roller 43 forms part of a slide mechanism S described later. The link part 6 is pivotally connected to the backrest part 4 at a portion above the portion in which the roller 43 is provided.

The link part 6 is a single piece having a straight rod shape, and has a proximal end portion connected to the upper frame 22 of the base 2 (the proximal end connection portion 61) and a distal end portion connected to a lateral side of the backrest part 4 (the distal end connection portion 62). The link part 6 of this embodiment is connected to the main frame part 41 through a bracket 45 fixed to the lateral side of the main frame part 41. The second arm 724 of a driving force transmission part 72 is connected to an intermediate position in the longitudinal direction of the link part 6 (intermediate connection portion 63). A driving force including a forward and backward component is input from the second arm 724 to the link part 6 for reclining and standing the backrest part 4. The connection of each of the three connection portions 61 to 63 of the link part 6 is a connection that can pivot around the axis of the pivot shaft extending in the width direction. Therefore, the connection angle with the connection object is configured to change at each of the connection portions 61 to 63. The link part 6, which has a straight rod shape, is pivoted around the proximal end connection portion 61 connected to the upper frame 22 of the base 2. The link part 6 is configured so that as shown in FIG. 1, when the backrest part 4 is in the standing state, the longitudinal direction thereof is raised, and as shown in FIG. 2, when the backrest part 4 is in the reclining state, the longitudinal direction reclines with a position of the distal end portion located forward of the position of the proximal end portion. The distal end connection portion 62 between the backrest part 4 and the link part 6 moves along the pivoting trajectory centered on the proximal end connection portion 61 between the standing state and the reclining state of the backrest part 4. The pivoting range of the link part 6 is set to a range that does not inhibit the forward movement of the backrest part 4 by the slide mechanism S. The posture of the link part 6 changes according to the driving force input from the second arm 724, and the driving force is transmitted from the link part 6 to the backrest part 4 through the driving force transmission (from the intermediate connection portion 63 to the distal end connection portion 62) inside the link part 6, so that the posture of the backrest part 4 changes between the standing state and the reclining state.

In this embodiment, the second arm 724 is not directly connected to the backrest part 4, but is connected to the link part 6. That is, the second arm 724 does not move the backrest part 4 directly, but indirectly moves it through the link part 6. By doing so, the second arm 724 and the link part 6 can be moved so as not to interfere with an exterior material in the interior space surrounded by an exterior member (not shown) such as synthetic leather. In addition, since the second arm 724 moves the backrest part 4 indirectly through the link part 6, the massage machine 1 can increase the amount of reclining movement of the backrest part 4 as an output, relative to the amount of telescopic movement of an actuator 71 as an input which will be described later. That is, the massage machine 1 of this embodiment can achieve the reclining movement of the backrest part 4 with a small amount of power. Furthermore, the direction of reclining of the backrest part 4 can be regulated by indirectly moving the backrest part 4 through the link part 6.

The treatment part 5 includes the treatment element 51 which is sometimes called a “kneading ball”. Although the treatment part 5 generally has a plurality of treatment elements 51 (two elements separated from each other in the width direction in this embodiment), this is not essential and the treatment part 5 may have only one treatment element 51. The treatment element 51 is configured to move while applying pressure against the body of the user to provide treatment to the user.

The treatment part 5 is composed of the treatment element 51 and a support part 52 that physically supports the treatment element 51. The treatment part 5 has built-in lifting motor, kneading motor, tapping motor, and intensity adjusting motor in a box-shaped case, although they are not illustrated. The treatment part 5 has a rotation shaft provided with a pinion that engages the rack 42 of the backrest part 4, and the rotation shaft is rotated by a lifting motor. The driving force of the kneading motor or the tapping motor is transmitted to the support part 52 to realize the kneading or tapping motion.

The kneading motion is a motion realized by that, for example, a shaft with an eccentric cam (not illustrated) in the treatment part 5 is rotated by the kneading motor, and thereby the rotating motion of the eccentric cam is transmitted to the support part 52 to move the treatment element 51 in three dimensions. The tapping motion is a short-term reciprocating motion of the treatment element 51 toward the body of the user.

The treatment part 5 can be configured to provide treatment to the user by combining the kneading motion and the tapping motion to perform simultaneously these motions, for example, to treat the user. In addition to the kneading motion and/or the tapping motion, the treatment part 5 can provide treatment by repeatedly performing an operation in which the treatment element 51 presses against the user for a certain period of time and then moves away therefrom by driving an intensity adjusting motor.

The massage machine 1 of this embodiment further includes the actuator 71 that generates a driving force to recline and raise at least the backrest part 4, and the driving force transmission part 72 that transmits the driving force of the actuator 71 to the backrest part 4. The massage machine 1 includes the slide mechanism S which slides the pivot fulcrum 431 in the forward direction in accordance with the reclining of the backrest part 4.

The actuator 71 of this embodiment is a linear actuator that outputs a linear motion driving force. The direction of the driving force output by the actuator 71 is such that the extension direction is a forward and backward linear direction. Although the actuator 71 is an electric drive in this embodiment, the drive method (drive principle) is not particularly limited, and can be hydraulic driving, for example. Even in the case of an electric drive, the drive source included in the actuator 71 can be a rotary motor or a linear motor. The actuator 71 is angle-variably supported at the base 2 to accommodate movement of the seat part 3 in an oblique direction along the upper frame part 221 of the upper frame 22. Specifically, the back end portion of the actuator 71 is supported (axially supported) so as to be pivotable with respect to the horizontal axis, so that the swinging motion is possible in a predetermined range in the vertical direction.

The driving force transmission part 72 includes an input part 721 connected to an output part from which the driving force is taken out in the actuator 71, an intermediate transmission part 722 for transmitting the driving force input from the input part 721 in the width direction, the first arm 723 connected to both ends of the intermediate transmission part 722 for transmitting the driving force to the seat part 3, and the second arm 724 connected to the intermediate transmission part 722 for transmitting the driving force to the backrest part 4. Thus, the driving force of the actuator 71 is directly transmitted to the seat part 3 (through the first arm 723) and the backrest part 4 (through the second arm 724), respectively. Therefore, when the actuator 71 is driven, the seat part 3 and the backrest part 4 move simultaneously. In such a configuration of this embodiment, it is easy to set the reclining and the standing of the backrest part 4 to allow the backrest part 4 to move in a trajectory according to the purpose of reducing the amount of movement of the backrest part 4 to the back side, compared to, for example, a configuration in which the driving force is indirectly transmitted to the backrest part 4 via the seat part 3, or the transmission is made in the opposite direction.

The first arm 723 and the second arm 724 are shaped such that, in a lateral side view, a lower portion extends in the vertical direction and an upper portion extends diagonally through a curved portion. The upper portion of the first arm 723 extends diagonally forward as it advances upward, and the second arm 724 extends diagonally backward as it advances upward. The first arm 723 is pivotally connected to a lower portion of the frame part 31 in the seat part 3 (see FIG. 4). The second arm 724 is pivotally connected to the link part 6 by the intermediate connection portion 63. Each of both connections is a pivotal connection centered on a pivot shaft extending in the width direction. The upper end of the second arm 724 is positioned above the upper end of the first arm 723 when the backrest part 4 is in the standing state. The first arm 723 is fixedly connected to the intermediate transmission part 722. On the other hand, the second arm 724 is pivotally connected to the intermediate transmission part 722. Therefore, the lower portion of the second arm 724 is positioned along the vertical direction when the backrest part 4 is in the standing state (FIG. 1). The lower portion of the second arm 724 pivots so as to fall backward when the backrest part 4 is reclined (FIG. 2). By means of the second arm 724 which pivots to change its posture in this way, it is possible to reliably transmit the driving force from the actuator 71 to the link part 6 while preventing the second arm 724 from being subjected to unfavorable force (torsion, strain, etc.) in response to the reclining of the backrest part 4.

The slide mechanism S is provided over the seat part 3 and the backrest part 4. The slide mechanism S includes a guiding part S1 provided in the seat part 3, which moves forward and backward, to extend in the front and back direction, and a guided part S2 provided in the backrest part 4 to move along the guiding part S1. A pair of the guiding part S1 and the guided part S2 is provided on each of the left and right sides. Since the guiding part S1 is provided in the seat part 3, the entire guiding part S1 moves forward as the seat part 3 moves forward. In this embodiment, the guiding part S1 is a rail 32 fixed to the seat part 3, and the guided part S2 is a roller 43 (rotating wheel or wheel) that rotates along the rail 32. The roller 43 is a part having the pivot fulcrum 431 around which the backrest part 4 is reclined and raised. The backrest part 4 of this embodiment is supported on the side of the base 2 at two places, that is, the roller 43 and the link part 6.

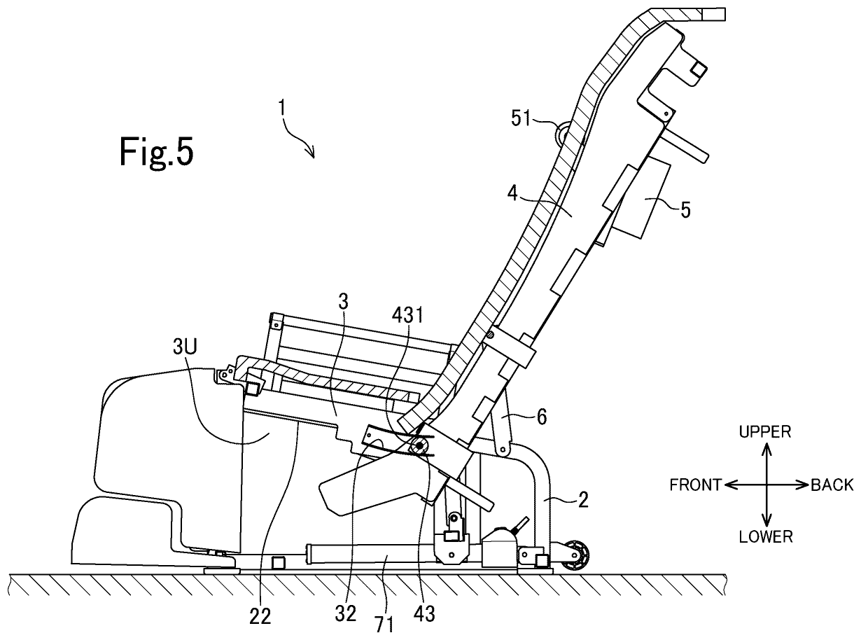

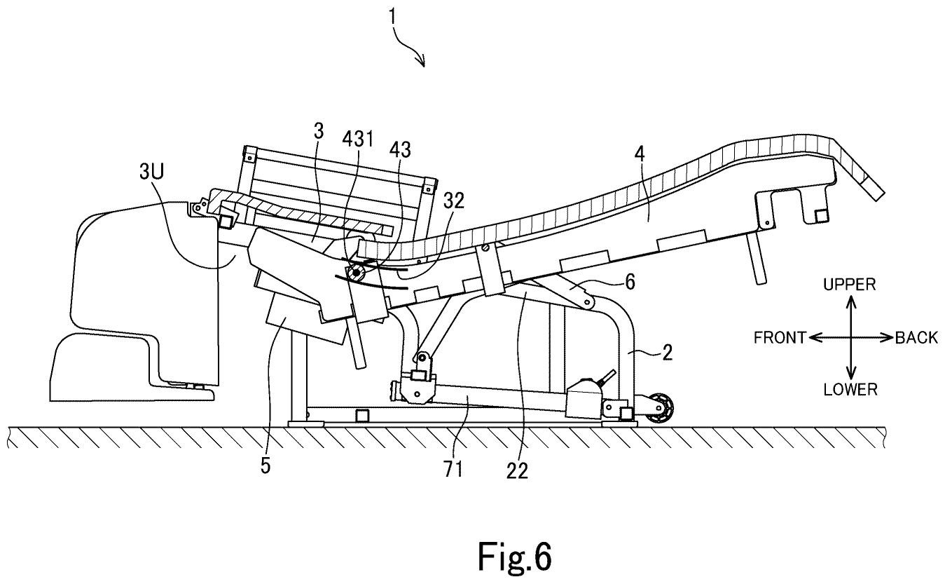

The rail 32 has a “[” shape (or “C” shape) having, in the vertical section, a longitudinal portion attached to the seat part 3 and transverse portions extending laterally from both upper and lower ends of the longitudinal portion. The roller 43 rotates while abutting on at least the lower transverse portion. The roller 43 moves along the inner surface of the rail 32 between the back position shown in FIG. 5 (standing state of the backrest part 4) and the forward position shown in FIG. 6 (reclining state of the backrest part 4). The rail 32 is not provided on the base 2 which is fixedly provided, but on the seat part 3 which moves forward and backward with respect to the base 2. Therefore, even if the dimension in the front and back direction of the rail 32 is formed small, the movement range of the roller 43 in the massage machine 1 can be secured greatly by the amount of movement of the seat part 3. Therefore, in the massage machine 1 of this embodiment, the rail 32 can be shortened.

The front and back ends of the rail 32 are open. However, it can be configured such that the front and/or back ends are closed. The opening portion between the transverse portions is open inward in the width direction. The rail 32 has a shape that is curved in an arc in a lateral side view (when viewed from the lateral side of the massage machine 1). In this embodiment, the rail 32 is defined as having a curved arc shape at a constant curvature. The curve is downwardly convex. Since the rail 32 has a curved shape that is downwardly convex, the roller 43 provided in the backrest part 4 is located above the intermediate position in the front and back direction according to the shape of the rail 32 when positioned on the front side. Since the front end portion of the backrest part 4 can be positioned at an upper position close to the seat part 3 in accordance with such movement of the roller 43, the treatment element 51 can be operated at a position closer to the buttocks and thighs of the user, and the treatment effect on the buttocks and/or thighs (of which, especially the back side) can be enhanced. It can be configured such that the rail 32 has a straight shape which is not curved in the lateral side view.

According to the massage machine 1 of this embodiment that provides the slide mechanism S as mentioned above, the backrest part 4 is reclined while being slid in the forward direction by the slide mechanism S which slides the pivot fulcrum 431 in the forward direction. For this reason, the massage machine 1 can reduce the amount of movement of the reclining backrest part 4 to the back side by the amount of sliding movement in the forward direction. Further, in the massage machine 1 of this embodiment, the seat part 3 moves so as to protrude forward at the same time as the reclining of the backrest part 4. The amount of movement of the backrest part 4 to the back side can also be reduced by the movement of the seat part 3 described above. Since the moving distance of the backrest part 4 to the forward side can be saved by the slide mechanism S compared to the configuration that the slide mechanism S is not provided, the dimension in the front and back direction of the base 2 can be reduced.

In this embodiment, the backrest part can be shifted forward by two elements, that is, the guiding part S1 and the guided part S2 according to the reclining. For this reason, the configuration can be simplified and made low-cost compared to the case in which the same operation as the slide mechanism S is realized by, for example, the link mechanism. Further, in this embodiment, the forward shifting accompanied by the reclining of the backrest part 4 can be realized by the combination of the rail 32 and the roller 43, which are general structural elements and have shapes easy to manufacture.

Next, the massage machine 1 of this embodiment includes a detection part 8 for detecting a physical quantity that changes in response to the reclining of the backrest part 4, and a control part 9. Note that the control part 9 is schematically illustrated in FIG. 1. However, the illustrated content is intended only for indication of the existence of the control part 9, and is not intended to limit the positional relationship of the control part 9 in the massage machine 1 or the connection relationship to the detection part 8. The detection part 8 is a sensor that detects the movement amount of the output part, which is provided in the actuator 71 itself in this embodiment, as the above-mentioned physical quantity. There is an approximately one-to-one (it does not have to be a strict one-to-one) correlation between the amount of movement of the output part and the reclining angle of the backrest part 4. The control part 9 is functioned, for example, in this embodiment, by a comprehensive control part that controls the entire massage machine 1. This is not essential, and, it can be configured such that a dedicated control part is provided separately from the comprehensive control part mentioned above to control exclusively the movement of the treatment element 51.

As mentioned above, the front end portion of the backrest part 4 is located on the lower side of the seat part 3 when the backrest part 4 is in the reclined position. The control part 9 restricts movement of the treatment element 51 to the front end portion when the detection part 8 detects a physical quantity corresponding to such a reclining state of the backrest part 4 in which the treatment element 51 is unable to provide treatment to the buttocks and/or thighs of the user through the seat part 3. In other words, the control part 9 prohibits movement of the treatment element 51 to the front end portion when the detection part 8 detects a physical quantity corresponding to such a reclining state of the backrest part 4 in which the treatment element 51 is unable to provide treatment to the buttocks and/or thighs of the treatment element through the seat part 3. A range indicated by the reference code 4F in FIG. 7 is a range roughly corresponding to the front end portion in which the treatment element 51 is located when the treatment element 51 provides treatment to the buttocks and/or thighs, and a range indicated by the reference code 4B is roughly a range (general massage range) in which the treatment element 51 is located when the treatment element 51 provides treatment to portions except for the buttocks and/or thighs (neck, shoulders, back, lower back, etc.).

By such control by the control part 9, when the reclining state of the backrest part 4 is in the standing state (FIG. 1 and FIG. 7) or a position approximate thereto, and the treatment element 51 cannot provide treatment to the buttocks and/or thighs of the user through the seat part 3 (i.e., the treatment element 51 is positioned away from the buttocks and/or thighs of the user even if the treatment element 51 is positioned in the front end portion of the backrest part 4), the treatment element 51 can be positioned without being displaced from the effective treatment range in the backrest part 4 by prohibiting movement of the treatment element 51 to the front end portion of the backrest part 4 in which the treatment effect is not caused to the buttocks and/or thighs.

Further, the control part 9 does not restrict (prohibit) movement of the treatment element 51 to the front end portion when the control part 9 determines that the reclining state of the backrest part 4 allows the treatment element 51 to provide treatment to the buttocks and/or thighs of the user through the seat part 3. For example, when the user operates the operation part to select the treatment content for the treatment of the buttocks and/or thighs (or the treatment content including the treatment for the buttocks and/or thighs), the control part 9 reclines the backrest part 4 and moves the treatment element 51 to the front end portion. The control part 9 reclines the backrest part so that treatment can be provided to the buttocks and/or thighs. This allows the massage machine 1 to tilt the backrest part 4 appropriately and move the treatment element 51 to the front end portion, and to move it to the treatment site, so that the treatment can be performed at the site desired for the user.

According to the massage machine 1 of this embodiment configured as described above, the amount of movement of the reclining backrest part 4 to the back side can be reduced. Therefore, the amount of movement to the back side of the massage machine 1 can be made small when the backrest part 4 is reclined. Accordingly, even if a wall or a pillar is located around the massage machine 1, the restriction on the installation position of the massage machine 1 can be reduced because an empty space to be secured on the back side of the massage machine 1 can be reduced.

Although one embodiment of the present disclosure has been described above, the present disclosure is not limited to the above-mentioned embodiment, and various modifications can be made within departing the scope of the present disclosure.

For example, the guiding part S1 is provided on the seat part 3 that moves forward and backward in the above-mentioned embodiment. However, the configuration is not limited thereto, and the guiding part S1 can be provided on the base 2, which is the fixedly provided side.

The guided part S2 is the roller 43 that rotates along the rail 32 that is the guiding part S1 in the above-mentioned embodiment. However, the configuration is not limited thereto, and it can be configured to provide a slider part (not shown) that moves forward and backward by sliding without rotation. In this case, the pivot fulcrum 431 is provided in the slider part, and the slider part supports the backrest part 4. The rail of the slide mechanism S including the slide part in this way can have a linear shape in the lateral side view. That is, the longitudinal portion of the rail, which is attached to the seat part 3, can be rectangular. In order to correspond to the above-mentioned shape of the rail, the slider part can have a rectangular parallelopiped shape. The rail of the slide mechanism, of which the longitudinal portion is thus rectangularly formed, is disposed parallel to the seating surface (i.e., horizontally), or is disposed to have a front side facing up. It should be noted that even in the case of the configuration provided with the slider part, the rail can have a shape that is curved in an arc in the lateral side view (when viewed from the lateral side view of the massage machine 1) as in the above-mentioned embodiment, and in this case, the slider part has a shape that can be moved along the curved rail. Further, the slider part can be cylindrical, for example, and thus the shape of the slider part is not particularly limited.

Although the slider part is comprised of a combination of the rail and the roller as in the above-mentioned embodiment, an opposite configuration to the above-mentioned embodiment, in which the guiding part S1 is a roller and the guided part S2 is a rail, can be adopted. In this case, the pivot fulcrum 431 is provided in the rail (not shown), and the rail is configured to support the backrest part 4.

The rail 32 of the above-mentioned embodiment is configured to have a shape that is curved in an arc in the lateral side view. However, the configuration is not limited to this, it can have a shape extending in a straight line, or it can have a curved shape with a plurality of curvatures.

Although the actuator 71 outputs the linear motion driving force in the above-mentioned embodiment, the actuator 71 can be configured to output a rotational motion driving force (such as an electric motor). In this case, the direction in which the driving force exerts can be changed accordingly in the driving force transmission part 72.

The driving force transmission part 72 of the above-mentioned embodiment includes the first arm 723 for transmitting the driving force of the actuator 71 to the seat part 3 and the second arm 724 for transmitting the driving force to the backrest part 4. However, the means for transmitting the driving force of the actuator 71 to the seat part 3 or the backrest part 4 is not particularly limited, and various means such as a link mechanism can be employed. However, it is advantageous to adopt the arms 723, 724 such as the above-mentioned embodiment in that the configuration can be simplified and a reduced size.

In the above-mentioned embodiment, when the backrest part 4 is reclined, the seat part 3 and the backrest part 4 are configured to be linked with each other and moved simultaneously, but there can be a time difference between the movements of both parts. If the time difference is provided, any one of them can move first, while the remaining one can subsequently move. The times required for movements of the seat part 3 and the backrest part 4 can be different from each other.

An object to be detected by the detection part 8 is the amount of the movement of the output part of the actuator 71 in the above-mentioned embodiment, but any object can be adopted as long as it is a physical quantity that changes in response to the reclining of the backrest part 4. Such a physical quantity may be, for example, the reclining angle of the backrest part 4 or the second arm 724, or the travel distance pertaining to the entry of the backrest part 4 into the space 3U below the seat part 3.

In the above-mentioned embodiment, the detection part 8 is provided to detect a physical quantity that changes in response to the reclining of the backrest part 4. However, the configuration is not limited to this, and it is also possible to restrict (prohibit) movement of the treatment part 51 to the front end portion on the condition that, for example, the user selects buttocks or thighs as a treatment site by the operation part provided in the remote control or the body of the massage machine 1. In this case, the control part 9 detects that the reclining state of the backrest part 4 is such that the treatment element 51 cannot provide treatment to the buttocks or thighs of the user through the seat part 3, through the operation status of the remote control or the like (without using the detection part 8), and in this case, the movement of the treatment element 51 to the front end portion is restricted (prohibited).

The structure and action of the above-mentioned embodiment will be summarized. The embodiment is a massage machine 1 including a base 2; a seat part 3 disposed at the base 2; a backrest part 4 located on a back side of the seat part 3 and reclinable relative to the base 2 while being supported by a pivot fulcrum 431, and being configured to support a treatment element 51 that moves while applying pressure against the body of a user to provide treatment to the user; an actuator 71 that generates a driving force to recline and raise at least the backrest part 4; a driving force transmission part 72 that transmits the driving force of the actuator 71 to the backrest portion 4; and a slide mechanism S that slides the pivot fulcrum 431 in the forward direction in accordance with the reclining of the backrest part 4.

According to this configuration, the slide mechanism S slides the pivot fulcrum 431 in the forward direction, so that the backrest part 4 is reclined while being slid in the forward direction. Therefore, it is possible to reduce the amount of movement of the reclining backrest part 4 to the back side.

The slide mechanism S can be configured to include a guiding part S1 disposed at the seat part to extend in a front and back direction, and a guided part S2 disposed at the backrest part and configured to move along the guiding part S1.

According to this configuration, forward shifting of the backrest part 4 accompanied by the reclining can be realized by the two elements, that is, the guiding part S1 and the guided part S2.

It can be configured such that the guiding part S1 is a rail 32 fixed to the seat part 3, and the guided part S2 is a roller 43 that rotates along the rail 32, the rail 32 having a shape that is curved in an arc when viewed from a lateral side of the massage machine 1.

According to this configuration, the backrest part 4 can be shifted in the forward direction in accordance with the reclining by combining the rail 32 and the roller 43, which are general structural elements.

It can be configured such that the massage machine 1 further includes a control part 9, in which the backrest part 4 has a front end portion that is located below the seat part 3 when the backrest part is reclined, and at this position, the treatment element 51 is located below the seat part 3 to be capable of providing treatment to the buttocks or thighs of the user, the control part 9 being configured to restrict movement of the treatment element 51 to the front end portion when a reclining state of the backrest part 4 is detected as a state in which the treatment element 51 is unable to provide treatment to the buttocks or thighs of the user through the seat part 3.

It can be configured such that the massage machine further includes a detection part 8 that detects a physical quantity that changes in response to the reclining of the backrest part 4, in which the front end portion of the backrest part 4 is located below the seat part 3 when the backrest part 4 is reclined, and at this position, the treatment element 51 is located below the seat part 3 to be capable of providing treatment to the buttocks or thighs of the user, the control part 8 being configured to restrict movement of the treatment element 51 to the front end portion when the detection part 8 detects the physical quantity corresponding to a state in which the reclining state of the backrest part 4 that does not allow the treatment element 51 to provide treatment to the buttocks or thighs of the user through the seat part 3.

According to this configuration, when the reclining state of the backrest part 4 is such a state in which the treatment element 51 cannot provide treatment to the buttocks or thighs of the user through the sitting part 3, the movement of the treatment element 51 toward the front end portion of the backrest part 4 in which the treatment effect on the buttocks or tights is not caused is restricted to perform treatment without causing uselessness.

Further, it can be configured such that the front end portion of the backrest part 4 is located below the seat part 3 when the backrest part 4 is reclined, and at this position the treatment element 51 is located below the seat part 3 to be capable of providing treatment to the buttocks or thighs of the user, the control part 9 being configured to recline the backrest part 4 when the treatment is provided to the buttocks or thighs of the user.

According to this configuration, when the treatment is provided to the buttocks or thighs, the control part 9 allows the treatment element 51 to move to the front end portion to thereby move to a treatment side, so that the treatment can be performed at a site desirable for the user.

Thus, according to the above-mentioned implementation, it is possible to reduce the amount of movement of the reclining backrest part 4 to the back side. Therefore, the amount of movement to the back side of the massage machine 1 can be made small when the backrest part 4 is reclined.

Although the massage machine 1 of this embodiment is described above, the present disclosure is not limited to the above embodiment, and it is possible to change the design accordingly within the scope of the intention of the present disclosure. In addition, the effect of the present disclosure is not limited to the above-mentioned implementation. That is, the presently disclosed mode of implementation should be considered exemplary in all respects and not restrictive. The scope of the present disclosure is shown not by the above description but by the scope of the claims. It is also intended that the scope of the present disclosure include all changes within the same meaning and scope as the claims.

What is claimed is:

1. A massage machine comprising:
a base;
a seat part disposed at the base;
a backrest part located on a back side of the seat part and reclinable relative to the base while being supported by a pivot fulcrum, and being configured to support a treatment element that moves while applying pressure against the body of a user to provide treatment to the user;
an actuator that generates a driving force to recline and raise at least the backrest part;
a driving force transmission part that transmits the driving force of the actuator to the backrest part; and
a slide mechanism that slides the pivot fulcrum in a forward direction in accordance with the reclining of the backrest part.

2. The massage machine according to claim 1, wherein the slide mechanism comprises a guiding part disposed at the seat part to extend in a front and back direction, and a guided part disposed at the backrest part and configured to move along the guiding part.

3. The massage machine according to claim 2, wherein the guiding part is a rail fixed to the seat part, and the guided part is a roller that rotates along the rail, the rail having a shape that is curved in an arc when viewed from a lateral side of the massage machine.

4. The massage machine according to claim 1, further comprising a control part, wherein
the backrest part has a front end portion that is located below the seat part when the backrest part is titled, and
the treatment element is located below the seat part to be capable of providing treatment to the buttocks or thighs of the user,
the control part being configured to restrict movement of the treatment element to the front end portion when a reclining state of the backrest part is detected as a state in which the treatment element is unable to provide treatment to the buttocks or thighs of the user through the seat part.

5. The massage machine according to claim 4, further comprising a detection part that detects a physical quantity that changes in response to the reclining of the backrest part, wherein
the front end portion of the backrest part is located below the seat part when the backrest part is reclined, and the treatment element is located below the seat part to be capable of providing treatment to the buttocks or thighs of the user,
the control part being configured to restrict movement of the treatment element to the front end portion when the detection part detects the physical quantity corresponding to a state in which the reclining state of the backrest part that does not allow the treatment element to provide treatment to the buttocks or thighs of the user through the seat part.

6. The massage machine according to claim 4, wherein the front end portion of the backrest part is located below the seat part when the backrest part is reclined, and the treatment part is located below the seat part to be capable of providing treatment to the buttocks or thighs of the user,
the control part being configured to recline the backrest part when the treatment is provided to the buttocks or thighs of the user.
